(19) United States
(12) Patent Application Publication
(10) Pub. No.: US 2014/0087030 A1
(43) Pub. Date: Mar. 27, 2014

(54) READY TO EAT DEEP FRIED SEAFOOD AS APPETIZER AND SNACK FOOD

(71) Applicant: Alice Chang, South Pasadena, CA (US)

(72) Inventor: Alice Chang, South Pasadena, CA (US)

(21) Appl. No.: 13/864,123

(22) Filed: Apr. 16, 2013

Related U.S. Application Data
(60) Provisional application No. 61/705,626, filed on Sep. 25, 2012.

(51) Int. Cl. A23L 1/31

(52) U.S. Cl. CPC A23L 1/3103
USPC 426/92; 426/643

(57) ABSTRACT

The ready to eat deep fried seafood as appetizer and snack food comestible includes ingredients combined in proportions substantially including: seafood; cooking oils; and seasonings. The seafood is prepared by washing and removing internal organs. The seafood and seasonings are combined. The ready to eat deep fried seafood as appetizer and snack food are prepared by intermixing the seasonings with the seafood and cooking oils, when prepared are deep fried, the seafood when deep fried are high in nutrition, including carbohydrates, vitamins, minerals, and antioxidants suitable for readily consuming as an appetizer and a snack.

### CROSS-REFERENCE TO RELATED APPLICATION

The present application is related to and claims priority from prior provisional application Ser. No. 61/705,626, filed Sep. 25, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

The following includes information that may be useful in understanding the present invention(s). It is not an admission that any of the information provided herein is prior art, or material, to the presently described or claimed inventions, or that any publication or document that is specifically or implicitly referenced is prior art.

### BACKGROUND OF THE INVENTION

1. Field of the Invention

The present invention relates generally to the field of comestibles and more specifically relates to ready to eat deep fried seafood as appetizer and snack food.

2. Description of the Related Art

The majority of people desire a healthy lifestyle; however many individuals do not feel that they have time to cook healthy meals in modern society. Due to rushed schedules many people tend to snack between meals when they are hungry. Snacking on unhealthy food may lead to obesity and other serious health problems. When snacking, many individuals choose to eat fatty foods that are high in cholesterol such as potato chips, simply because they are convenient. Many foods such as seafood are healthier than red meats for example; however seafood may not typically come in a form that is readily conducive for snacking.

Seafood is generally any form of sea life regarded as food by humans. Seafood prominently includes fish and shellfish in most societies. Shellfish include various species of molluscs, crustaceans, and echinoderms. Seafood is consumed all over the world; it provides the worlds prime source of high-quality protein: 14-16% of the animal protein consumed world-wide; over one billion people rely on seafood as their primary source of animal protein. Fish is among the most common food eaten. Research over the past few decades has shown that the nutrients and minerals in seafood can make improvements in brain development and reproduction and has highlighted the role for seafood in the functionality of the human body. A more efficient and convenient option is needed to provide seafood as a snack food that is delicious and ready to consume on a regular basis.

Various attempts have been made to solve the above-mentioned problems such as those found in U.S. Pat. and Pub. Nos. U.S. Pat. Nos. 5,492,711; 3,512,993; 7,294,355; 7,662,422; 2009/0274791; U.S. Pat. Nos. 4,557,942; and 7,906,164. This art is representative of snack comestibles. None of the above inventions and patents, taken either singly or in combination, is seen to describe the invention as claimed.

Ideally, ready to eat deep fried seafood as appetizer and snack food should provide a fried and seasoned seafood comestible that is conductive for healthy consumption as an appetizer or snack food and desirable to eat and, yet would be able to be processed and manufactured at a modest expense. Thus, a need exists for healthy ready to eat seafood sausages and seafood balls to avoid the above-mentioned problems.

### BRIEF SUMMARY OF THE INVENTION

In view of the foregoing disadvantages inherent in the known seafood comestibles art, the present invention provides novel ready to eat deep fried seafood as appetizer and snack food. The general purpose of the present invention, which will be described subsequently in greater detail is to provide a fried and seasoned seafood comestible that is conductive for snacking and desirable to eat.

The purpose of the present invention is to create ready to eat deep fried seafood as appetizer and snack food to be served as appetizer or snack food. The invention is to provide people who eat at fast food restaurants the choice of seafood as appetizer, and people shopping for food the convenience of getting processed seafood. People who want a quick snack can now have seafood as an extra option, instead of potato chips, nuts, candies, cookies, etc.

A ready to eat deep fried seafood as appetizer and snack food comestible is disclosed herein comprising ingredients combined in proportions substantially including: at least one seafood; cooking oils; and seasonings. The seafood is prepared by washing and removing internal organs. The seafood and seasonings are combined. The ready to eat deep fried seafood as appetizer and snack food are prepared by intermixing the seasonings with the seafood and cooking oils, when prepared are deep fried, the seafood when deep fried are high in nutrition, including carbohydrates, vitamins, minerals, and antioxidants suitable for readily consuming as an appetizer and a snack.

Further, the seafood may comprise an outer coating. The outer coating, if used, is selected from the group consisting of bread crumbs, beer batter, egg batter, and cornmeal batter. The cooking oil is selected from the group consisting of corn oil, canola oil (rapeseed oil), sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, and other vegetable oils.

The at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots. The seasonings and flavorings can be added and mixed into the cooking oils before deep frying. And they can also be added and mixed into the seafood after deep frying. Cooked seafood is storable in at least one air tight container.

The seafood is cut into small pieces. When the seafood is cut into small pieces, the seafood is selected from the group consisting of fish, jellyfish, squid, cuttlefish, octopus, abalone, crab, lobster, conch, sea cucumber, and eel (including sea eel and freshwater eel). Whole pieces of seafood consist of shrimp, prawn, crayfish, scallop, clam, mussel, roe, krill, sea urchin, and snail (including land snail, sea snail and freshwater snail), etc. The small pieces of seafood comprise wedges and cubical shapes. The wedges comprise an approximate length of 3 to 4-inches. The cubical shapes comprise an approximate length of each side about 1 to 2-inches. Other shapes and sizes can also be used, such as shapes of cylinders, spheres, discs, and so on.

A method of preparing ready to eat deep fried seafood as appetizer and snack food is also disclosed herein comprising the steps of: washing seafood; removing bones, shells, and internal organs from the seafood when necessary; cutting the seafood into small pieces of varying shapes and sizes; placing an outer layer to the seafood if needed; deep frying the seafood in cooking oils; adding seasonings and flavorings; and packaging the seafood, as prepared into air tight containers to preserve freshness as a snack food.

The present invention holds significant improvements and serves as ready to eat deep fried seafood as appetizer and snack food. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat deep fried seafood as appetizer and snack food, constructed and operative according to the teachings of the present invention.

FIG. 1 shows a perspective view illustrating ready to eat deep fried seafood as appetizer and snack food according to an embodiment of the present invention.

FIG. 2 is a perspective view illustrating the ready to eat deep fried seafood as appetizer and snack food as used to make embodiments of the present invention of FIG. 1.

FIG. 3 is a flowchart illustrating a method of preparing the ready to eat deep fried seafood as appetizer and snack food according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to comestibles and more particularly to ready to eat deep fried seafood as appetizer and snack food as used to improve the convenience of preparing and eating of (including) fried and seasoned seafood as a snack food.

Generally speaking, the purpose, as previously mentioned is to create fried and seasoned seafood comestibles cut into small pieces and stored in air tight packages. The seafood snack may be made by deep frying and seasoning of small cut pieces of seafood and whole pieces of seafood. The seafood can have no outer layer. Or an outer layer of bread crumbs or batter, such as beer batter, egg batter, or cornmeal batter, can be added. The seafood snack once prepared may be packaged into small air tight containers to preserve freshness. The containers can be made from paper, plastic, glass, metal.

The seafood is prepared by washing, cleaning, and removal of shells and internal organs. Then the seafood is cooked by deep frying of small cut pieces of seafood such as fish, jellyfish, squid, cuttlefish, octopus, abalone, crab, lobster, conch, sea cucumber, and eel (including sea eel and freshwater eel); and whole pieces of seafood such as whole pieces of seafood such as shrimp, prawn, crayfish, scallop, clam, mussel, roe, krill, sea urchin, and snail (including land snail, sea snail and freshwater snail).

The seafood is deep fried in cooking oils, such as corn oil, canola oil (rapeseed oil), sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, and other vegetable oils. Seasonings such as salt, pepper, onion, garlic, ginger, curry, chili, vinegar, lemon, lime, peppermint, basil, thyme, parsley, rosemary, soup stock and broth, clove, cinnamon, coriander, cumin, shallots are added for flavor. The seasonings and flavorings can be added and mixed into the cooking oils before deep frying. Further, the seasonings can also be added and mixed into the seafood after deep frying.

The fried and seasoned seafood can be served at fast food restaurants as an appetizer or side dish. They can also be packaged into small air tight containers to preserve freshness, and served as snack food. The container can be made of paper, plastic, glass, metal. The fried and seasoned seafood can have no outer layer or an outer layer of bread crumbs or batter, such as beer batter, egg batter, or cornmeal batter, can be added.

Preparation and cooking of the fried and seasoned seafood may require a lot of time and energy. By creating ready to eat seafood as appetizer and snack food, people can consume seafood conveniently. The processed seafood is also a new choice of snack food. Ready to eat seafood as appetizer or snack food provides good nutrition, including protein, vitamins and minerals, and low in cholesterol.

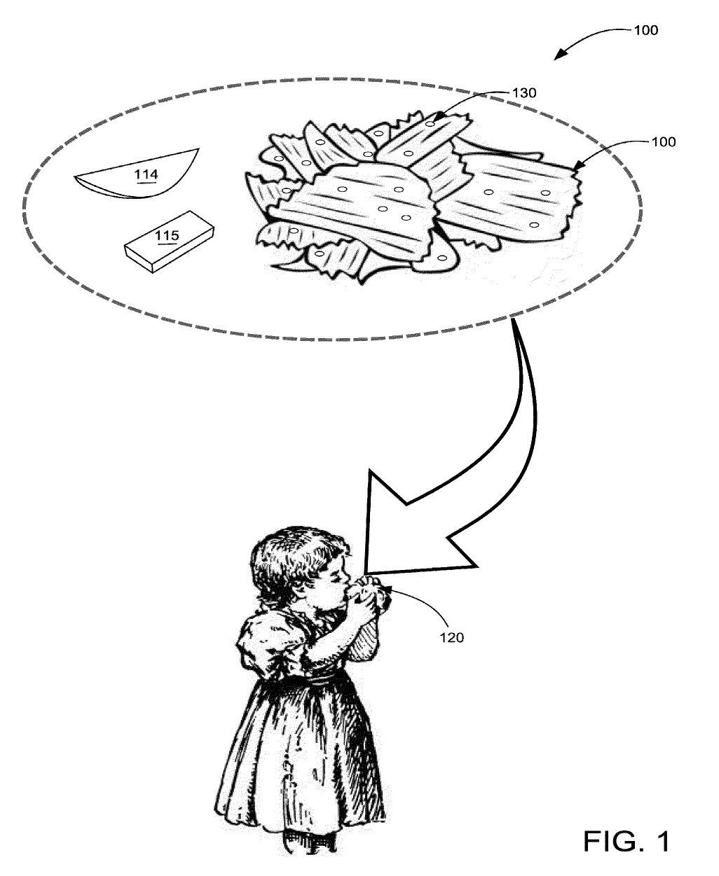

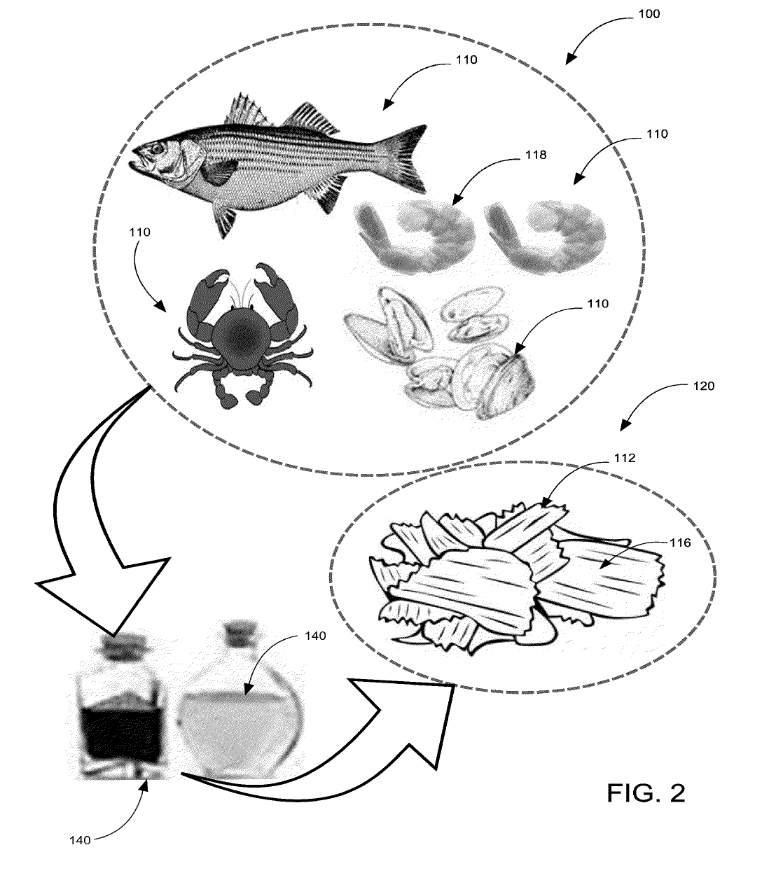

Referring to the drawings by numerals of reference there is shown in FIGS. 1-2 perspective views illustrating seafood 110 for use as ready to eat deep fried seafood 120 as appetizer and snack food (once prepared to be eaten) in FIG. 1 and in FIG. 2, to be prepared both according to an embodiment of the present invention.

Ready to eat deep fried seafood 120 as appetizer and snack food 100 comprises ingredients combined in proportions substantially including: at least one seafood 110; cooking oils 140; and seasonings 130. Seafood 110 is prepared by washing and removing internal organs. Further, seafood 110 and seasonings 130 are combined. Ready to eat deep fried seafood 120 as appetizer and snack food 100 are prepared by intermixing seasonings 130 with seafood 110 and cooking oils 140, when prepared are deep fried, seafood 110 when deep fried are high in nutrition, including carbohydrates, vitamins, minerals, and antioxidants suitable for readily consuming as appetizer and snack food 100.

Seafood 110 may comprises no outer coating in ready to eat deep fried seafood 120 as appetizer and snack food 100 in certain embodiments. In alternate embodiments seafood 110 may comprise an outer coating; however this version is less preferred nutritionally. When an outer coating is used, outer coating is selected from the group consisting of bread crumbs, beer batter, egg batter, and cornmeal batter. In embodiments using an outer coating seasonings and/or spices may be incorporated therein.

When preparing ready to eat deep fried seafood 120 as appetizer and snack food 100, cooking oil 140 is selected from the group consisting of corn oil, canola oil (rapeseed oil), sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, and other vegetable oils, however other cooking oils may be used. At least one seasoning 130 is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots, according to user-taste preference.

Seafood 110 may cut into small pieces 112 or whole pieces 118. Seafood 110 when cut into small pieces 114 is selected from the group consisting of fish, jellyfish, squid, cuttlefish, octopus, abalone, crab, lobster, conch, sea cucumber, and eel (including sea eel and freshwater eel). Small pieces 112 of seafood 110 may comprise wedges 114, cubical shapes 115, or thin slices 116 of varying dimensions in the form of chips to be packaged as appetizer and snack food 100. Wedges 114 preferably comprise an approximate length of 3 to 4-inches while cubical shapes 115 preferably comprise an approximate length of 1 to 2-inches. Seafood 110 when comprising whole pieces 118 is selected from the group consisting of shrimp, prawn, crayfish, scallop, clam, mussel, roe, krill, sea urchin, and snail (including land snail, sea snail and freshwater snail). Seafood(s) 110 may also include at least 2 combinations of seafood(s) 110. Many other seafood 110 and combinations thereof may be envisioned to be used and still be considered within the scope of the present invention.

Ready to eat deep fried seafood 120 as appetizer and snack food 100 can be packaged into air tight containers to preserve freshness until ready to serve. The containers can be made of paper, plastic, glass, metal. In this way the present invention may be easily shipped and stored.

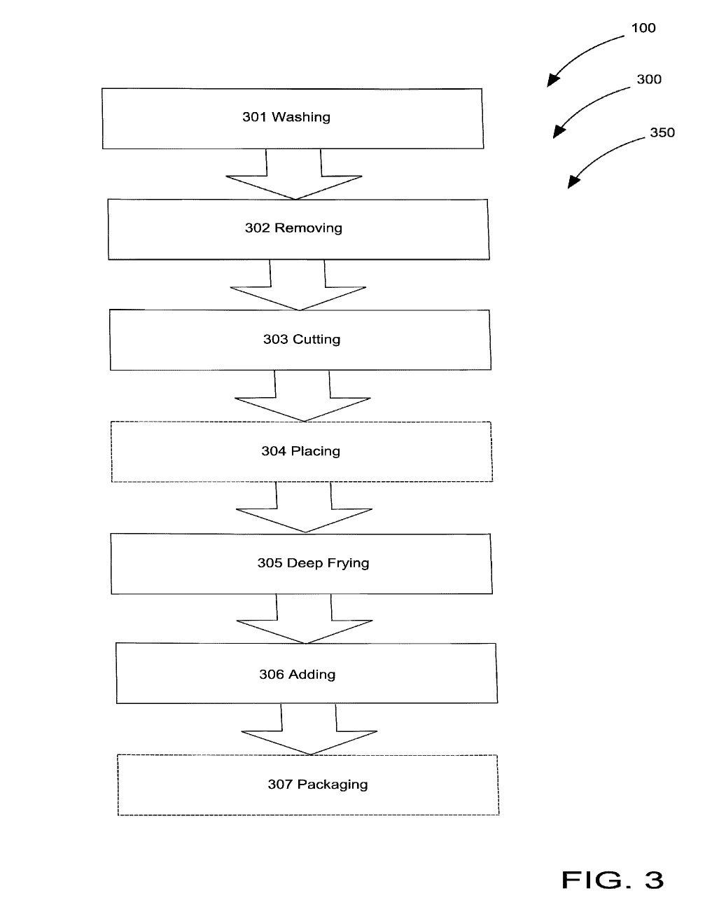

Referring now to FIG. 3, flowchart 350 illustrating a method of preparing 300 ready to eat deep fried seafood 120 as appetizer and snack food 100, according to embodiments of the present invention of FIGS. 1-2.

Method of preparing 300 ready to eat deep fried seafood 120 as appetizer and snack food 100 comprises the steps of: step one 301 washing seafood 110; step two 302 removing bones, shells, and internal organs from seafood 110 when necessary; step three 303 cutting seafood 110 into small pieces 112 of varying shapes and sizes; step four 304 placing an outer layer to seafood 110 if needed; step five 305 deep frying seafood 110 in cooking oils 140; step six 306 adding seasonings 130 and flavorings; and step seven 307 packaging seafood 110, as prepared into air tight containers to preserve freshness as appetizer and snack food 100.

It should be noted that steps 304 and 307 are optional steps and may not be implemented in all cases. Optional steps of method 500 are illustrated using dotted lines in FIG. 3 so as to distinguish them from the other steps of method 300.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat deep fried seafood as appetizer and snack food comprising ingredients combined in proportions substantially including:
at least one seafood;
at least one cooking oil; and
at least one seasoning;
wherein said seafood is prepared by washing and removing internal organs;
wherein said seafood and said seasonings are combined;
wherein said ready to eat deep fried seafood as appetizer and snack food are prepared by intermixing said seasoning with said seafood and said cooking oil, when prepared are deep fried, said seafood when deep fried are high in nutrition, including carbohydrates, vitamins, minerals, and antioxidants suitable for readily consuming as an appetizer and a snack.

2. The ready to eat deep fried seafood as appetizer and snack food of claim 1 wherein said seafood comprises no outer coating.

3. The ready to eat deep fried seafood as appetizer and snack food of claim 1 wherein said seafood comprises an outer coating.

4. The ready to eat deep fried seafood as appetizer and snack food of claim 3 wherein said outer coating is selected from the group consisting of bread crumbs, beer batter, egg batter, and cornmeal batter.

5. The ready to eat deep fried seafood as appetizer and snack food of claim 1 wherein said at least one cooking oil is selected from the group consisting of corn oil, canola oil (rapeseed oil), sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, and vegetable oils.

6. The ready to eat deep fried seafood as appetizer and snack food of claim 1 wherein said seafood is cut into small pieces.

7. The ready to eat deep fried seafood as appetizer and snack food of claim 6 wherein said seafood when cut into said small pieces is selected from the group consisting of fish, jellyfish, squid, cuttlefish, octopus, abalone, crab, lobster, conch, sea cucumber, and eel.

8. The ready to eat deep fried seafood as appetizer and snack food of claim 6 wherein said small pieces of said seafood comprise wedges.

9. The ready to eat deep fried seafood as appetizer and snack food of claim 8 wherein said wedges comprise an approximate length of 3 to 4-inches.

10. The ready to eat deep fried seafood as appetizer and snack food of claim 6 wherein said small pieces of said seafood comprise cubical shapes.

11. The ready to eat deep fried seafood as appetizer and snack food of claim 10 wherein said cubical shapes comprise an approximate length on each side of about 1 to 2-inches.

12. The ready to eat deep fried seafood as appetizer and snack food of claim 6 wherein said small pieces of said seafood comprise thin slices of varying dimensions in the form of chips to be packaged as snack food.

13. The ready to eat deep fried seafood as appetizer and snack food of claim 1 wherein said seafood comprises whole pieces.

14. The ready to eat deep fried seafood as appetizer and snack food of claim 11 wherein said seafood when comprising whole pieces is selected from the group consisting of shrimp, prawn, crayfish, scallop, clam, mussel, roe, krill, sea urchin, and snail.

15. The ready to eat deep fried seafood as appetizer and snack food of claim 1 wherein said seafood(s) includes at least 2 combinations of said seafood(s).

16. The ready to eat deep fried seafood as appetizer and snack food of claim 1 wherein said at least one seasoning is selected from the group consisting salt, pepper, onion, garlic, ginger, curry, chili, vinegar, lemon, lime, peppermint, basil, thyme, parsley, rosemary, soup stock and broth, clove, cinnamon, coriander, cumin, and shallots.

17. The ready to eat deep fried seafood as appetizer and snack food of claim 1 wherein said cooked seafood is storable in at least one air tight container.

18. A ready to eat deep fried seafood as appetizer and snack food comprising ingredients combined in proportions substantially including:
at least one seafood;
at least one cooking oil; and
at least one seasoning;
wherein said seafood is prepared by washing and removing internal organs;
wherein said seafood and said seasonings are combined;
wherein said seafood comprises an outer coating;
wherein said outer coating is selected from the group consisting of bread crumbs, beer batter, egg batter, and cornmeal batter;
wherein said cooking oil is selected from the group consisting of corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, and other vegetable oils;
wherein said seafood is cut into small pieces;
wherein said seafood when cut into said small pieces is selected from the group consisting of whole pieces of seafood such as shrimp, prawn, crayfish, scallop, clam, mussel, roe, hill, sea urchin, and snail;
wherein said small pieces of said seafood comprise wedges;
wherein said wedges comprise an approximate length of 3 to 4-inches;
wherein said seasoning is selected from the group consisting salt, pepper, onion, garlic, ginger, curry, chili, vinegar, lemon, lime, peppermint, basil, thyme, parsley, rosemary, soup stock and broth, clove, cinnamon, coriander, cumin, shallots;
wherein said ready to eat deep fried seafood as appetizer and snack food is storable in at least one air tight container; and
wherein said ready to eat deep fried seafood as appetizer and snack food are prepared by intermixing said seasoning with said seafood and said cooking oil, when prepared are deep fried, said seafood when deep fried are high in nutrition, including carbohydrates, vitamins, minerals, and antioxidants suitable for readily consuming as an appetizer and a snack.

19. A method of preparing ready to eat deep fried seafood as appetizer and snack food comprising the steps of:
washing seafood;
removing bones, shells, and internal organs from said seafood when necessary;
cutting said seafood into small pieces of varying shapes and sizes;
placing an outer layer to said seafood if needed;
deep frying said seafood in cooking oils; and
adding seasonings and flavorings.

20. The method of claim 19 further comprising the step of packaging said seafood, as prepared into air tight containers to preserve freshness as a snack food.
